(19) United States
(12) Patent Application Publication
(10) Pub. No.: US 2019/0369202 A1
(43) Pub. Date: Dec. 5, 2019

(54) Geolocation Based On Radio Frequency Communication And Video Imagery

(71) Applicant: VaaS International Holdings, Inc., Fort Worth, TX (US)

(72) Inventors: Shawn B. Smith, Portola Valley, CA (US); Todd Hodnett, Cleburne, TX (US); Mark Richard Kruse, Fort Worth, TX (US)

(21) Appl. No.: 16/427,785

(22) Filed: May 31, 2019

Related U.S. Application Data
(60) Provisional application No. 62/678,481, filed on May 31, 2018.

(51) Int. Cl. G01S 5/02; H04N 7/18; G01S 11/06

(52) U.S. Cl. CPC G01S 5/0257; G01S 11/06; H04N 7/18

(57) ABSTRACT

Methods and systems for estimating a location of a wireless electronic device within an environment and linking the presence of the wireless electronic device to a specific set of images collected in the vicinity of the estimated location are presented herein. In one aspect, the physical location of a wireless electronic device at a particular time is estimated based on the strength or time of reception of radio frequency signals collected by three or more geo-locator modules. Each of the three or more geo-locator modules identify a media access control (MAC) address associated with a wireless electronic device. In a further aspect, the geolocation of each identified MAC addressed device is tracked and recorded over time. In another further aspect, the wireless electronic device is linked to images collected by an imaging device while the wireless electronic device remains within a monitored area of the imaging device.

### CROSS REFERENCE TO RELATED APPLICATION

The present application for patent claims priority under 35 U.S.C. § 119 from U.S. provisional patent application Ser. No. 62/678,481, entitled “Geolocation Based On Radio Frequency Communication And Video Imagery,” filed May 31, 2018, the subject matter of which is incorporated herein by reference.

### TECHNICAL FIELD

The described embodiments relate to geolocation and identification systems and tools.

### BACKGROUND INFORMATION

Closed circuit television (CCTV) systems are typically employed to monitor the presence and movements of people and objects in publically accessible areas. Modern, networked CCTV units record a stream of digital images and upload the recorded images to memory over a digital network. In some examples, the recorded stream of digital images is rendered onto a display at a remote location for evaluation by a human user in real time. In some other examples, a stream of digital images stored in memory (e.g., on a dedicated image server system, cloud based server system, etc.) is rendered on a display for a human user at a later time.

Over time, CCTV systems generate an enormous amount of video footage. In principle, a user of a CCTV system may track the whereabouts of a person or object of interest based on previously recorded images of the person or object of interest within the field of view of a CCTV unit. However, the identification of a person or object of interest based on video footage stored by conventional CCTV systems is complicated for at least two reasons. First, the sheer volume of footage available for review makes it difficult and time consuming to identify particular persons or objects of interest if the precise time that the person or object of interest was located within the field of view of a particular CCTV unit is not known. In practice, the whereabouts of a person or object of interest is not precisely known before review of CCTV video footage. As a result, considerable time and effort is expended to review images over a long period of time to identify the whereabouts of a person or object of interest. Second, it is often difficult to precisely identify a person or object of interest within a given image because the critical identifying features of the person or object of interest are not easily captured within the field of view of the CCTV unit. For example, a person's facial features may be hidden by a hat, glasses, etc., or the position and orientation of the CCTV unit relative to the recorded subject simply fails to capture identifying features within the field of view of the CCTV unit.

Improvements to existing systems are desired to facilitate the identification of persons or objects of interest within images collected by a CCTV unit.

### SUMMARY

Methods and systems for estimating a location of a wireless electronic device within an environment and linking the presence of the wireless electronic device to a specific set of images collected in the vicinity of the estimated location are presented herein.

In one aspect, the physical location of a wireless electronic device at a particular time is estimated based on radio frequency signals collected by three or more geo-locator modules. Each of the three or more geo-locator modules identify a media access control (MAC) address associated with a wireless electronic device. In some embodiments, the location of the wireless electronic device is estimated based on the strength of a RF signal received by the three or more geolocator modules from the wireless electronic device with the identified MAC address. In some other embodiments, the location of the wireless electronic device is estimated based on the relative time of reception of a signal transmitted from the wireless electronic device with the identified MAC address and received by the three or more geolocator modules.

In a further aspect, the geolocation of each identified MAC addressed device is tracked and recorded over time. This results in a time series set of location data associated with each detected MAC addressed device.

In another further aspect, a GeoLocation (GL) server is configured to identify a characteristic of a location where the MAC addressed device is present based on the time series of location data.

In another further aspect, the shape of each geographic area within the field of view of each of a plurality of imaging units is described in a geographic information system (GIS) shape file associated with the corresponding imaging unit. In this manner, the geographic location of any point within the field of view of a particular imaging unit is associated with that particular imaging unit. Furthermore, a GL server can query image data collected by the particular imaging unit.

In another further aspect, the MAC address associated with a wireless electronic device is linked to a specific set of images collected by an imaging device while the estimated location of the wireless electronic device remains within the monitored area of the imaging device. A record linking the MAC address and the specific set of collected images is stored in a memory.

In another further aspect, the strength of the received RSSI signals at each geolocator module are calibrated to various locations of transmission to compensate for objects that attenuate RF signals (e.g., traffic, humans, buildings, etc.).

The foregoing is a summary and thus contains, by necessity, simplifications, generalizations, and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a simplified diagram illustrative of a Geolocation and Image Linking (GIL) system 100 that includes a number of geolocator modules 101 and a geolocation server 150, along with a number of imaging modules 110 and an image server 160.

FIG. 2 is a simplified diagram illustrative of a plurality of GL records stored in memory.

FIG. 3 is a simplified diagram illustrative of a plurality of GIS mapping records stored in memory.

FIG. 4 is a simplified diagram illustrative of a plurality of image records stored in memory.

FIG. 5 is a simplified diagram depicting a computing device operable to acquire GL records from the GL server and image records from the image server.

FIG. 6 depicts a geolocator module in further detail.

FIG. 7 is a simplified diagram illustrative of a plurality of GL instances stored in memory.

FIG. 8 is a flowchart illustrative of a method 200 for generating a GIL record associated with a MAC address in one example.

FIG. 9 is a flowchart illustrative of a method 300 for generating a GIL record associated with a MAC address in another example.

### DETAILED DESCRIPTION

Reference will now be made in detail to background examples and some embodiments of the invention, examples of which are illustrated in the accompanying drawings.

Methods and systems for estimating a location of a wireless electronic device within an environment and linking the presence of the wireless electronic device to a specific set of images collected in the vicinity of the estimated location are presented herein.

In one aspect, the physical location of a wireless electronic device at a particular time is estimated based on radio frequency signals collected by three or more geo-locator modules. Each of the three or more geo-locator modules identify a media access control (MAC) address associated with a wireless electronic device. In some embodiments, the location of the wireless electronic device is estimated based on the strength of the signals received by the three or more geolocator modules from the wireless electronic device with the identified MAC address. In some other embodiments, the location of the wireless electronic device is estimated based on the relative time of reception of a signal transmitted from the wireless electronic device with the identified MAC address and received by the three or more geolocator modules.

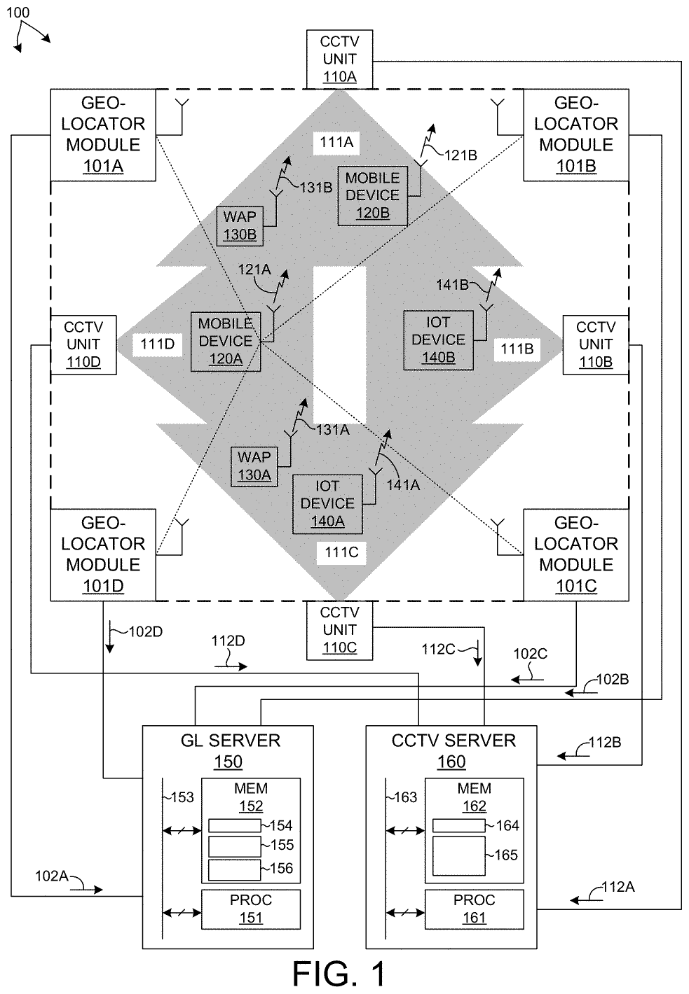

FIG. 1 is a diagram illustrative of a Geolocation and Image Linking (GIL) system 100 that includes a Geolocation (GL) system including a number of GeoLocator modules 101A-D and a GeoLocator (GL) server 150, and an imaging system including a number of imaging modules (e.g., CCTV units 110A-D) and a video management system (e.g., CCTV server 160).

FIG. 1 depicts a number of different wireless electronic devices within the fields of view of CCTV units 110A-D and within range of wireless receivers of geolocator modules 101A-D. The depicted wireless electronic devices include mobile computing devices 120A-B (e.g., mobile phones, tablets, etc.), wireless access points 130A-B (e.g., router, Wi-Fi hotspot, etc.), and internet of things (IOT) devices 140A-B (e.g., wireless thermostats, printers, lighting devices, etc.). Each of these devices broadcasts its MAC address periodically. For example, mobile phones frequently broadcast a request to connect (e.g., once per minute) and wireless access points frequently broadcast the MAC addresses of connected devices (e.g., once per second). As depicted in FIG. 1, mobile devices 120A-B transmit signals 121A-B, respectively, indicating their MAC address. Similarly, IOT devices 140A-B transmit signals 141A-B indicating their MAC address, and wireless access points 130A-B transmit signals 131A-B indicating their MAC address and the MAC addresses of any connected devices.

In one aspect, each geolocator module 101A-D receives signals 121A-B, 131A-B, and 141A-B, and communicates signals 102A-D, respectively, to GL server 150. Signals 102A-D indicate the MAC address information associated with signals 121A-B, 131A-B, and 141A-B received by each geolocator module.

In some embodiments, signals 102A-D also include an indication of the signal strength (e.g., Received Signal Strength Indicator (RSSI)) associated with each received signal 121A-B, 131A-B, and 141A-B received by each geolocator module. In response to signals 102A-D, GL server 150 estimates a geolocation of any of mobile devices 120A-B, wireless access points 130A-B, and IOT devices 140A-B based on the relative strength of the received signals associated with a particular wireless electronic device. In one example depicted in FIG. 1, GL server 150 estimates a distance between each geolocator 101A-D and mobile device 120A based on the strength of signal 121A received by each geolocator module 101A-D. GL server 150 estimates the geospatial location of mobile device 120A based on the estimated distances and known geolocations of geolocator modules 101A-D. With four geolocator modules, the estimation of the geolocation of mobile device 120A is overdetermined, but the redundant information is useful to average out errors in the estimation of each distance between a geolocator module and mobile device 120A. In another example, GL server 150 selects the three strongest signals received by any set of geolocator modules (e.g., geolocator modules 101A-D) and the estimate of the geolocation of mobile device 120A is based on the three estimated distances between mobile device 120A and the corresponding geolocator modules. In this example, the estimation of the geolocation of mobile device 120A is mathematically well defined, for example, by triangulation.

In a further aspect, the strength of the received RSSI signals at each geolocator module are calibrated to various locations of transmission to compensate for objects that attenuate RF signals (e.g., traffic, humans, buildings, etc.). In one example, a set of known smartphone handsets (e.g., Apple, Samsung, etc.) are positioned in various locations throughout the monitored environment while transmitting their MAC addresses. The location of the handsets during each transmission is determined by a global positioning system and recorded. In addition, each geolocator module measures the RSSI of the received signals corresponding to each transmission at each known location. In this manner, a look-up table relating actual physical locations (i.e., described by GPS coordinates) and measured RSSI values corresponding to each location for each geolocator module is generated. In some examples, GL server 150 interpolates the look-up table to estimate the location of a MAC addressed device based on measured RSSI values.

In some other embodiments, signals 102A-D also include an indication of the time of reception associated with each received signal 121A-B, 131A-B, and 141A-B received by each geolocator module, respectively. In response to signals 102A-D, GL server 150 estimates a geolocation of any of mobile devices 120A-B, wireless access points 130A-B, and IOT devices 140A-B based on the relative time of reception of the received signals associated with a particular transmission from a particular wireless electronic device. In one example depicted in FIG. 1, GL server 150 estimates a distance between each geolocator 101A-D and mobile device 120A based on the relative time of reception of signal 121A transmitted by mobile device 120A and received by each geolocator module 101A-D at different times. GL server 150 estimates the geospatial location of mobile device 120A based on the relative time of reception of signal 121A and the known geolocations of geolocator modules 101A-D.

FIG. 7 depicts an amount of memory 157 including a plurality of GeoLocation (GL) instances 197 stored in memory 157. A GL instance includes an indication of the particular MAC address recognized by each of the GL modules, the known geolocation of each GL module, and the time of reception by each GL module of a signal transmitted by a wireless electronic device. In one example, a GL instance includes an indication of the particular MAC address recognized by each of the GL modules 101A-D, the known geolocation of each GL module 101A-D, and the time of reception by each GL module of signal 121A transmitted by mobile device 120A. In one example, GL server 150 determines the GL module having the earliest time of reception of signal 121A. The distance between this particular GL module and the transmitting device (i.e., mobile device 120A) is an unknown value, X. However, the distances between each of the other three GL modules and mobile device 120A are functions of the unknown distance, X, and the relative times of reception of the transmitted signal. For example, as depicted in FIG. 7, the time of reception by GL module 101A is the earliest time, and the distance between GL module 101A and mobile device 120A is an unknown value, X. The distance between GL module 101B and mobile device 120A is the unknown value, X, plus the speed of light, C, multiplied by the difference between the time of reception of signal 121A by GL module 101B and the time of reception of signal 121A by GL module 101A. Similarly, the distance between GL module 101C and mobile device 120A is the unknown value, X, plus the speed of light, C, multiplied by the difference between the time of reception of signal 121A by GL module 101C and the time of reception of signal 121A by GL module 101A, and the distance between GL module 101D and mobile device 120A is the unknown value, X, plus the speed of light, C, multiplied by the difference between the time of reception of signal 121A by GL module 101D and the time of reception of signal 121A by GL module 101A. In a Cartesian coordinate system, the distances between each GL module and mobile device 120A are illustrated in the set of equations (1).

d(T, A)=X=\sqrt{(x_{A}−x_{T})²+(y_{A}−y_{T})²}

d(T, B)=X+C(T_{TB}−T_{TA})=\sqrt{(x_{B}−x_{T})²+(y_{B}−y_{T})²}

d(T, C)=X+C(T_{TC}−T_{TA})=\sqrt{(x_{C}−x_{T})²+(y_{C}−y_{T})²}

d(T, D)=X+C(T_{TD}−T_{TA})=\sqrt{(X_{D}−x_{T})²+(y_{D}−y_{T})²} (1)

In one example, GL server 150 estimates the geolocation of the transmitting device (e.g., mobile device 120A) based on the set of equations (1). As depicted by the set of equations (1), there are four equations and three unknown values: the geolocation of the transmitting device, (XT, YT), and the distance between the transmitting device and GL module 101A. With four geolocator modules, the estimation of the geolocation of mobile device 120A is overdetermined, but the redundant information is useful to average out errors in the estimation of the geolocation of mobile device 120A. In another example, the estimate of the geolocation of mobile device 120A is based on the relative time of reception of signal 121A by three geolocator modules. In this example, the estimation of the geolocation of mobile device 120A is mathematically well defined.

As described hereinbefore, the estimation of the location of the transmitting device (e.g., mobile device 120 depicted in FIG. 1) depends on the precision of the measured time of reception of the transmitted signal across the set of receiving GL modules. To estimate the geolocation of a transmitting device with an accuracy of approximately one meter, the precision of the measurement of the time of reception of the transmitted signal across the set of receiving GL module must be in a range of 1-10 nanoseconds. Thus, time must be periodically synchronized across the set of receiving GL modules with an accuracy of 1-10 nanoseconds. In one example, each GL module employs a precision time protocol (PTP) transceiver to achieve synchronization to a reference clock with less than ten nanosecond precision. An exemplary precision PTP transceiver is the DP83640 Precision Phyter™ device manufactured by Texas Instruments, Inc., Dallas, Tex. (USA). In some embodiments, the reference clock is a clock on board one of the GL modules that is periodically updated to maintain an estimate of real time based on communication with a network based time source such as a network time server.

In a further aspect, the geolocation of each identified MAC addressed device is tracked and recorded over time. This results in a time series set of location data associated with each detected MAC addressed device.

In another further aspect, GL server 150 is configured to identify a characteristic of a location where the MAC addressed device is present based on the time series of location data. In one example, GL server 150 determines that the MAC addressed device is located at “home” if the MAC addressed device is located within a small spatial area at least 80% of the time from 8:00 PM to 6:00 AM. In another example, GL server 150 determines that the MAC addressed device is located at “work” if the MAC addressed device is located within a small spatial area at least 80% of the time from 9:00 AM to 5:00 PM.

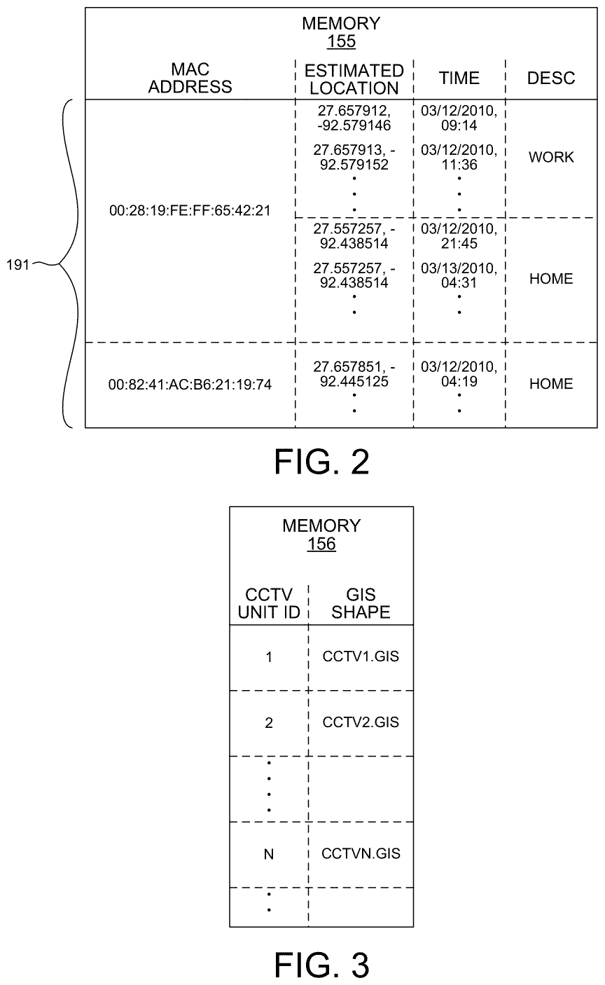

FIG. 2 depicts memory 155 including a plurality of GeoLocation (GL) records 191 stored in memory 155. A GL record includes an indication of the particular MAC address recognized by the GL system, and the time and the estimated location of the wireless electronic device that transmitted the MAC address at each recognition instance. In addition, the GL record includes an indication of a characteristic of a location where the MAC addressed device is determined to be present based on the time series of location data for one or more time intervals. In other examples, additional information may be stored with any GL record. For example, an index identifier may be associated with each GL record. The index identifier may be useful to facilitate sorting and organizing the plurality of GL records.

In addition, FIG. 1 depicts a number of imaging modules (e.g., CCTV units 110A-D), and an imaging server (e.g., CCTV server 160). Each CCTV unit collects images (e.g., still images, video images, etc.) of a geographic area within the field of view of each CCTV unit, respectively. For example, geographic areas 111A-D correspond to the field of view of CCTV units 110A-D, respectively.

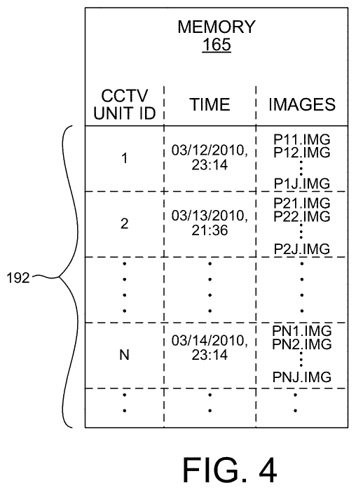

FIG. 4 depicts memory 165 including a plurality of image records 192 stored in memory 165. A image record includes an indication identifying the particular CCTV unit that acquired the images, a time of image acquisition, and the acquired images. In other examples, additional information may be stored with any image record. For example, an index identifier may be associated with each image record. The index identifier may be useful to facilitate sorting and organizing the plurality of image records.

In another further aspect, the shape of each geographic area within the field of view of each CCTV unit is described in a geographic information system (GIS) shape file associated with the corresponding CCTV unit. For example, as depicted in FIG. 3, memory 156 of GL server 150 includes a GIS record including an identification number associated with each imaging module and a corresponding GIS shape file associated with the field of view of each imaging unit. In this manner, the geographic location of any point within the field of view of a particular CCTV unit is associated with that particular CCTV unit. Furthermore, GL server can query image data collected by the particular CCTV unit on CCTV server 160.

In one example, an application running on a mobile handset accepts input from a user indicating an identification number (e.g., CCTV unit ID) of an imaging unit (e.g., a CCTV unit). The user then then walks around with the mobile handset recording GPS coordinates while viewing on the handset a series of images (e.g., video) collected by the imaging unit and communicated to the mobile handset. The user walks to the edges of the field of view of the imaging unit to define the boundaries of the GIS shape file. In another example, a user defines a GIS shape file associated with a particular imaging device by manually drawing (click by click) a GIS shape file using a GIS mapping program. The manually defined GIS shape file is then downloaded to the GL server 150 and associated with the particular imaging unit.

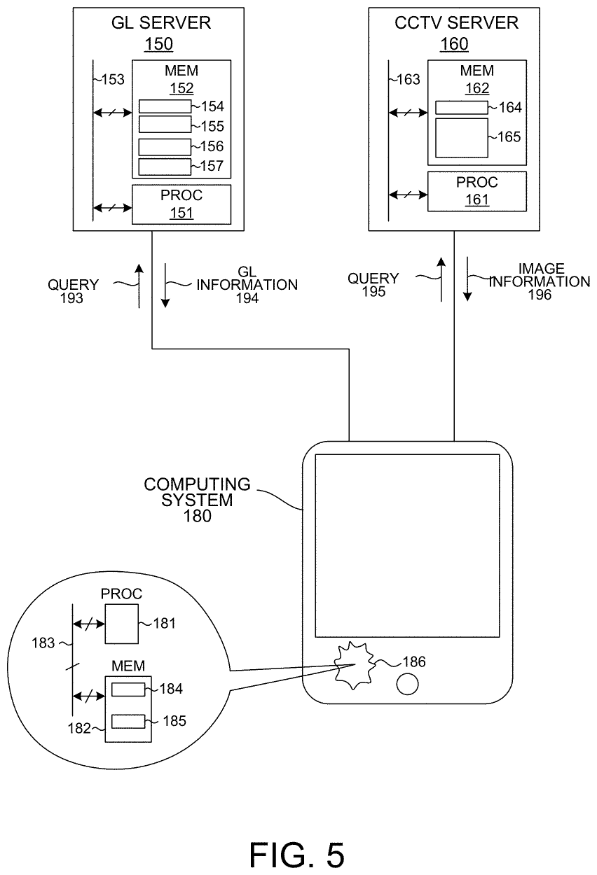

In some examples, the GL server provides MAC addresses recorded by the GL system within a specified area, time window, or both. In some examples, the GL server provides estimated locations, times, or both, associated with a particular MAC address. For example, FIG. 5 depicts a computing system 180 communicatively coupled to GL server 150. Computing system 180 communicates a query 193 to GL server 150. In one example, query 193 specifies a GIS area, time window, or both. In response, GL server 150 communicates GL information 194 including one or more MAC addresses that were identified within the specified GIS area, time window, or both to computing system 180.

In some examples, the specified area corresponds to a GIS shape file associated with a particular CCTV unit. In these examples, GL server 150 provides the MAC addresses of devices identified within the field of view of the particular CCTV unit by the GL system.

In some examples, the CCTV server provides image data recorded by a particular CCTV unit within a specified time window. For example, FIG. 5 depicts a computing system 180 communicatively coupled to CCTV server 160. Computing system 180 communicates a query 195 to CCTV server 160. In one example, query 195 specifies a particular CCTV unit (e.g., identified by its identification number) and a time window. In response, CCTV server 160 communicates image information 196 including image data recorded by the specified CCTV unit within the time window to computing system 180.

In one example, GL server 150 compares an estimated location of a MAC addressed device identified by the GL system with the GIS shape file associated with each CCTV unit (e.g., CCTV units 110A-D) to identify the particular CCTV unit having a field of view that includes the estimated location of the MAC addressed device. The CCTV server 160 is queried to obtain image records from that particular CCTV unit that include the estimated location at the time the MAC addressed device was identified by the GL system.

By querying GL server 150 and CCTV server 160, a user of computing device 180 may recover records indicating the time, location, and images of a specific MAC addressed device. In some other examples, a user may recover records indicating identified MAC addresses within a specified area, time window, or both, along with corresponding image data.

In another further aspect, the MAC address associated with a wireless electronic device is linked to a specific set of images collected by an imaging device while the estimated location of the wireless electronic device remains within the monitored area of the imaging device. A record linking the MAC address and the specific set of collected images is stored in a memory (e.g., memory 182).

Computing system 180 includes a processor 181 and a memory 182. Processor 181 and memory 182 may communicate over bus 183. In one example, memory 182 includes an amount of memory 184 that stores a number of GL and image records associated with one or more MAC addresses. Memory 182 also includes an amount of memory 185 that stores program code that, when executed by processor 181, causes mobile electronic device 180 to implement GL query and image query functionality by operation of query tool 186. By way of non-limiting example, computing system 180 may be a laptop computer, a smartphone, or a tablet computer operable to communicate with GL server 150 and CCTV server 160 over a wired communications network, wireless communications network, or both.

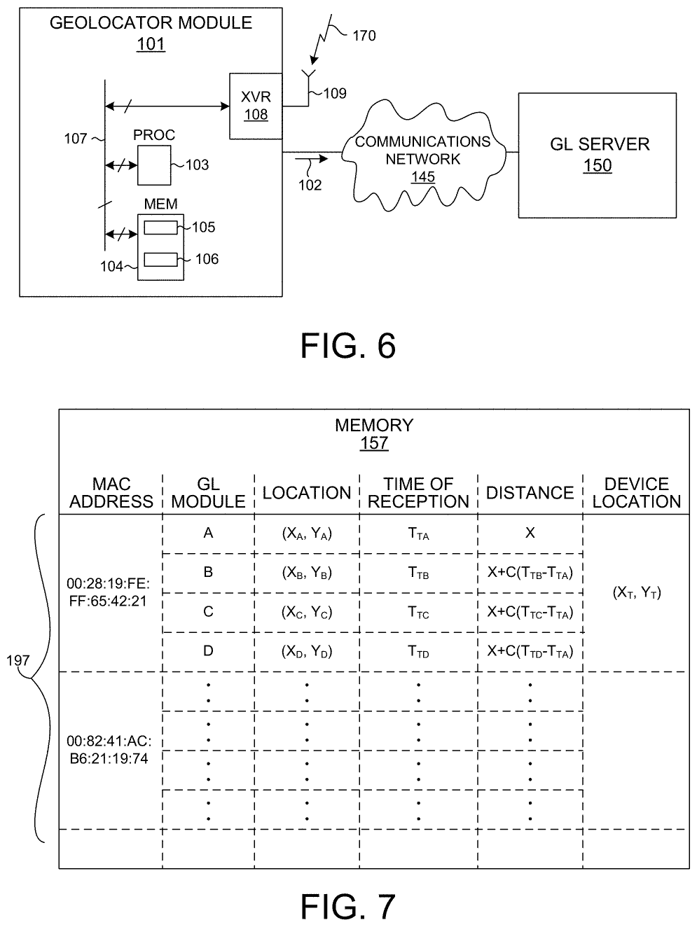

As depicted in FIG. 6, a geolocator module 101 is communicatively linked to GL server 150 via a communications network 145. However, a geolocator module 101 may be communicatively linked to GL server 150 by any communication link known to those skilled in the art. For example, geolocator module 101 may be communicatively linked to GL server 150 over a wired network, a local area network (LAN), a wireless communications network, or any other suitable communications network. In one example, a geolocator module 101 may be communicatively linked to the Internet via a wireless communication link adhering to the IEEE 802.11 protocol, Bluetooth protocol, or any other suitable wireless protocol, which, in turn, may be communicatively linked to GL server 150 by a wired communication link.

Similarly, a CCTV unit 110 may be communicatively linked to GL server 150 over a wired network, a local area network (LAN), a wireless communications network, or any other suitable communications network.

FIG. 6 depicts geolocator module 101 in one embodiment. As depicted in FIG. 6, geolocator module 101 includes an antenna 109 and a radio frequency transceiver 108 to receive signals 170 from a wireless electronic device in the vicinity of the geolocator module 101. In addition, geolocator module 101 includes a processor 103 and a memory 104. Processor 103 and memory 104 may communicate over bus 107. Memory 104 includes an amount of memory 105 that stores image information included as part of a GIL record. Memory 104 also includes an amount of memory 106 that stores program code that, when executed by processor 103, causes processor 103 to implement MAC address collection and RSSI collection or time of flight collection as described herein.

In some embodiments, each geolocator module 101 is in communication with GL server 150 to update an estimate of real time maintained on each module. In this manner, each geolocator module 101 determines the time of each MAC address capture based on an accurately updated, internal clock. In another example, the geolocator module 101 may update an estimate of real time maintained on each module based on communication with a network based time source such as a network time server.

GL server 150 includes a processor 151 and an amount of memory 152. Processor 151 and memory 152 may communicate over bus 153. Memory 153 includes an amount of memory 154 that stores a database program executable by processor 151. Exemplary, commercially available database programs include Oracle®, Microsoft SQL Server®, IBM DB2®, etc. Memory 152 also includes an amount of memory that stores an GL database 155 of GL records searchable by the database program executed by processor 151.

By way of non-limiting example, GL server 150 is operable to communicate with an external computing system (not shown) over a communications link.

In one example, GL server 150 is operable to receive an updated target MAC address list from an external computing system.

In another example, an external computing system requests a GL record associated with a particular MAC address, and in response, GL server 150 communicates the GL records associated with the particular MAC address to the external computing system.

Similarly, image server 160 includes a processor 161 and an amount of memory 162. Processor 161 and memory 162 may communicate over bus 163. Memory 163 includes an amount of memory 164 that stores a database program executable by processor 161. Exemplary, commercially available database programs include Oracle®, Microsoft SQL Server®, IBM DB2®, etc. Memory 162 also includes an amount of memory that stores an image database 165 of image records searchable by the database program executed by processor 161.

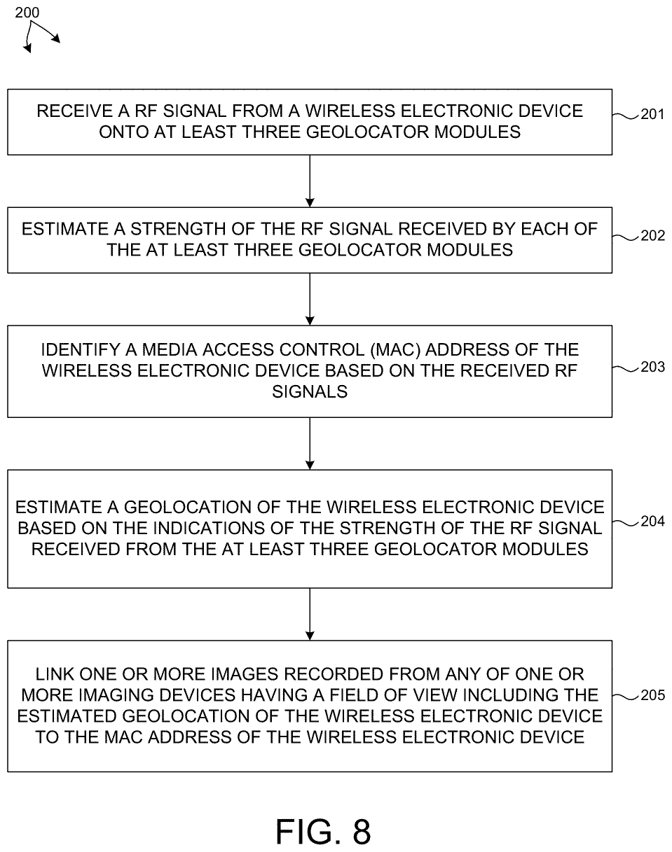

FIG. 8 illustrates a method 200 for generating a GIL record associated with a wireless electronic device. Method 200 is suitable for implementation by a GIL system such as GIL system 100 illustrated in FIG. 1 of the present invention. In one aspect, it is recognized that data processing blocks of method 200 may be carried out via a pre-programmed algorithm executed by one or more processors of GIL system 100, or any other general purpose computing system. It is recognized herein that the particular structural aspects of GIL system 100 do not represent limitations and should be interpreted as illustrative only.

In block 201, a RF signal is received from a wireless electronic device onto at least three geolocator modules.

In block 202, a strength of the RF signal received by each of the at least three geolocator modules is estimated.

In block 203, a MAC address of the wireless electronic device is identified based on the received RF signals.

In block 204, a geolocation of the wireless electronic device is estimated based on the indications of the strength of the RF signal received from the at least three geolocator modules.

In block 205, one or more images recorded from any of one or more imaging devices having a field of view including the estimated geolocation of the wireless electronic device are linked to the MAC address of the wireless electronic device.

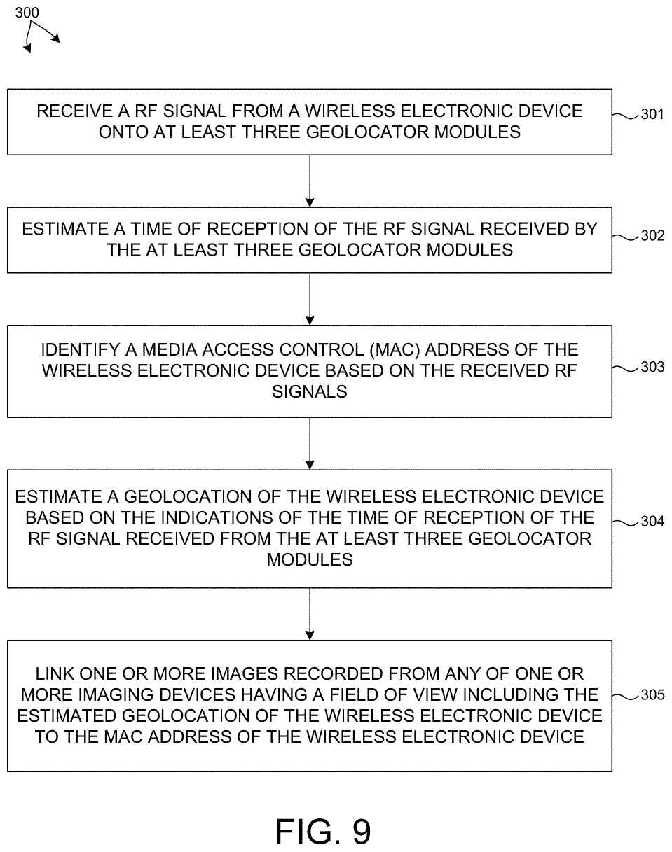

FIG. 9 illustrates a method 300 for generating a GIL record associated with a wireless electronic device. Method 300 is suitable for implementation by a GIL system such as GIL system 300 illustrated in FIG. 1 of the present invention. In one aspect, it is recognized that data processing blocks of method 300 may be carried out via a pre-programmed algorithm executed by one or more processors of GIL system 300, or any other general purpose computing system. It is recognized herein that the particular structural aspects of GIL system 300 do not represent limitations and should be interpreted as illustrative only.

In block 301, a RF signal is received from a wireless electronic device onto at least three geolocator modules.

In block 302, a time of reception of the RF signal received by each of the at least three geolocator modules is estimated.

In block 303, a MAC address of the wireless electronic device is identified based on the received RF signals.

In block 304, a geolocation of the wireless electronic device is estimated based on the indications of the time of reception of the RF signal received from the at least three geolocator modules.

In block 305, one or more images recorded from any of one or more imaging devices having a field of view including the estimated geolocation of the wireless electronic device are linked to the MAC address of the wireless electronic device.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A Geolocation and Image Linking (GIL) system comprising:
a plurality of GeoLocation (GL) modules, each of the plurality of GL modules comprising:
an antenna;
a Radio Frequency (RF) transceiver coupled to the antenna, the RF transceiver configured to receive a RF signal from a wireless electronic device; and
a computing system coupled to the RF transceiver, the computing system configured to:
estimate a strength of the RF signal; and
identify a Media Access Control (MAC) address of the wireless electronic device based on the RF signal;
one or more image recording devices configured to record images of an environment that includes the wireless electronic device;
a GL server communicatively coupled to each of the plurality of GL modules, the GL server configured to:
receive an indication of the strength of the RF signal and the MAC address from at least three of the plurality of GIL modules; and
estimate a geolocation of the wireless electronic device based on the indications of the strength of the RF signal received from the at least three of the plurality of GL modules; and
link one or more images from any of the one or more imaging devices to the MAC address of the wireless electronic device if a field of view of any of the one or more imaging devices includes the estimated geolocation of the wireless electronic device.

2. The GIL system of claim 1, the GL server further configured to:
store a GL record associated with the MAC address including the estimated geolocation and the one or more images linked to the MAC address.

3. The GIL system of claim 2, the GIL server further configured to:
receive a query from a computing device including an indication of a target MAC address; and
communicate one or more GL records associated with the target MAC address.

4. The GIL system of claim 1, wherein a clock of the GL server and a clock of each of the GL modules are synchronized with a network time server.

5. A method comprising:
receiving a RF signal from a wireless electronic device onto at least three geolocator modules;
estimating a strength of the RF signal received by the at least three geolocator modules;
identifying a Media Access Control (MAC) address of the wireless electronic device based on the received RF signals;
estimating a geolocation of the wireless electronic device based on the indications of the strength of the RF signal received from the at least three geolocator modules; and
linking one or more images recorded from any of one or more imaging devices having a field of view including the estimated geolocation of the wireless electronic device to the MAC address of the wireless electronic device.

6. The method of claim 5, further comprising:
storing a GeoLocation (GL) record associated with the MAC address including the estimated geolocation and the one or more images linked to the MAC address.

7. The method of claim 5, further comprising:
receiving a query from a computing device including an indication of a target MAC address; and
communicating one or more GL records associated with the target MAC address to the computing device.

8. The method of claim 5, further comprising:
receiving a query from a computing device including a geographic location and a time window;
identifying an imaging module having a field of view that includes the geographic location; and
identifying one or more MAC addressed devices having an estimated geolocation within the field of view of the imaging module.

9. A Geolocation and Image Linking (GIL) system comprising:
a plurality of GeoLocation (GL) modules, each of the plurality of GL modules comprising:
an antenna;
a Radio Frequency (RF) transceiver coupled to the antenna, the RF transceiver configured to receive a RF signal from a wireless electronic device; and
a computing system coupled to the RF transceiver, the computing system configured to:
estimate a time of reception of the RF signal; and
identify a Media Access Control (MAC) address of the wireless electronic device based on the RF signal;
one or more image recording devices configured to record images of an environment that includes the wireless electronic device;
a GL server communicatively coupled to each of the plurality of GL modules, the GL server configured to:
receive an indication of the time of reception of the RF signal and the MAC address from at least three of the plurality of GIL modules; and
estimate a geolocation of the wireless electronic device based on the indications of the time of reception of the RF signal received from the at least three of the plurality of GL modules; and
link one or more images from any of the one or more imaging devices to the MAC address of the wireless electronic device if a field of view of any of the one or more imaging devices includes the estimated geolocation of the wireless electronic device.

10. The GIL system of claim 9, the GL server further configured to:
store a GL record associated with the MAC address including the estimated geolocation and the one or more images linked to the MAC address.

11. The GIL system of claim 10, the GIL server further configured to:
receive a query from a computing device including an indication of a target MAC address; and
communicate one or more GL records associated with the target MAC address.

12. The GIL system of claim 9, wherein a clock of the GL server and a clock of each of the GL modules are synchronized with a network time server.

13. The GIL system of claim 9, wherein the clocks of each of the plurality of GL modules are synchronized with a precision of less than ten nanoseconds.

14. The GIL system of claim 9, wherein the estimating of the location of the wireless electronic device involves determining differences between a time of reception of the RF signal associated with one of the plurality of GL modules and the times of reception of the RF signal associated with the other GL modules of the plurality of GL modules.

15. A method comprising:
receiving a RF signal from a wireless electronic device onto at least three geolocator modules;
estimating a time of reception of the RF signal received by the at least three geolocator modules;
identifying a Media Access Control (MAC) address of the wireless electronic device based on the received RF signals;
estimating a geolocation of the wireless electronic device based on the indications of the time of reception of the RF signal received from the at least three geolocator modules; and
linking one or more images recorded from any of one or more imaging devices having a field of view including the estimated geolocation of the wireless electronic device to the MAC address of the wireless electronic device.

16. The method of claim 15, further comprising:
storing a GeoLocation (GL) record associated with the MAC address including the estimated geolocation and the one or more images linked to the MAC address.

17. The method of claim 15, further comprising:
receiving a query from a computing device including an indication of a target MAC address; and
communicating one or more GL records associated with the target MAC address to the computing device.

18. The method of claim 15, further comprising:
receiving a query from a computing device including a geographic location and a time window;
identifying an imaging module having a field of view that includes the geographic location; and
identifying one or more MAC addressed devices having an estimated geolocation within the field of view of the imaging module.

19. The method of claim 15, wherein the clocks of each of the plurality of GL modules are synchronized with a precision of less than ten nanoseconds.

20. The method of claim 15, wherein the estimating of the location of the wireless electronic device involves determining differences between a time of reception of the RF signal associated with one of the plurality of GL modules and the times of reception of the RF signal associated with the other GL modules of the plurality of GL modules.
